(19) United States
(12) Patent Application Publication
(10) Pub. No.: US 2013/0140363 A1
(43) Pub. Date: Jun. 6, 2013

(54) TAMPER EVIDENT CARD READER

(71) Applicant: Annmarie D. Hart, Seal Beach, CA (US)

(72) Inventor: Annmarie D. Hart, Seal Beach, CA (US)

(73) Assignee: MagTek, Inc., Seal Beach, CA (US)

(21) Appl. No.: 13/309,426

(22) Filed: Dec. 1, 2011

(51) Int. Cl. G06K 7/08; G06K 7/01

(52) U.S. Cl. 235/449; 235/435

(57) ABSTRACT

Tamper evident card readers in accordance with embodiments of the invention are disclosed. In one embodiment, a data-bearing instrument reader includes a sensor configured to read data from a data bearing instrument, circuitry configured to receive data from the sensor, a housing that at least partially contains the sensor and the circuitry, wherein at least a portion of the housing is translucent and the translucent portion of the housing is configured to permit visual inspection of the portions of the sensor and circuitry contained within the housing.

### FIELD OF THE INVENTION

The present invention relates generally to data-bearing instrument readers and more specifically to the detection of tampering with data bearing instrument readers.

### BACKGROUND OF THE INVENTION

Magnetic stripe-bearing documents, for example credit cards, banking cards, and debit cards, are a type of data-bearing instrument commonly used in a variety of transactions. Account data is recorded on a stripe of magnetic material on the card. The data may include the issuing bank ID, account number, account holder's name, and security codes for the account. Other types of data-bearing instrument that can be used in payment transactions include (but are not limited to) cards with security chips, “smart” chips, radio frequency identification (RFID) tags, and devices configured for near-field communications (NFC) such as cell phones.

When a magnetic stripe card is presented for payment, the magnetic stripe is read by a point-of-sale (POS) terminal, which extracts the data, sends it for validation to the bank, and waits for acceptance or rejection of the payment. If the transaction is accepted, the POS terminal prints a voucher (or obtains an electronic signature) and prints a receipt, and the merchant sees that the voucher is signed with the appropriate signature and provides the receipt with the purchased goods. The POS terminal can be a card reader or a device incorporating a card reader.

Prior art card readers are susceptible to being used by thieves to acquire account information from a customer's card. One of the many credit card fraud schemes is “skimming,” where an unauthorized person, often a dishonest employee of the merchant, places an unauthorized magnetic stripe reading device (a “skimmer” or “skimming device”) in or near the card slot or card path of the card reader. As a card is swiped through the reader, the skimming device captures data from the card's magnetic stripe.

An unauthorized skimming device may be hidden within the slot, so that it would be difficult or impossible for the consumer to notice that the reader has been modified for illicit purposes. Using a card reader in this way, a thief may acquire sufficient information from the magnetic stripe of a customer's card to create a forged copy of the original card or make unauthorized transaction on the account.

Card fraud is a growing problem worldwide. The current increased security measures for preventing such fraud increase the costs of credit card transactions and cause verification-related delays at points of sale that adversely affect both the merchants and the customers.

### SUMMARY OF THE INVENTION

Systems and methods for a tamper evident card reader in accordance with embodiments of the invention are disclosed. In one embodiment, a data-bearing instrument reader includes a sensor configured to read data from a data bearing instrument, circuitry configured to receive data from the sensor, a housing that at least partially contains the sensor and the circuitry, wherein at least a portion of the housing is translucent and the translucent portion of the housing is configured to permit visual. inspection of the portions of the sensor and circuitry contained within the housing.

In a further embodiment, the sensor is a magnetic read head.

In another embodiment, the magnetic read head is configured to encrypt data read from a data bearing instrument and output encrypted data to the circuitry.

In a still further embodiment, the housing comprises a card path.

In still another embodiment, the housing is configured to permit visual inspection of the card path.

In a yet further embodiment, at least a portion of the housing that forms the card path is translucent and permits visual inspection of the card path.

In yet another embodiment, the housing comprises a first wall, a second wall, and a reference edge that define the card path.

In a further embodiment again, the length of the first wall is less than the length of the second wall.

In another embodiment again, the length of the first wall is less than half the length of the second wall.

In a further additional. embodiment, the length of the first wall is less than a quarter of the length of the second wall.

In another additional. embodiment, the magnetic read head extends out of the second wall and the first wall covers the magnetic read head.

The data-bearing instrument of claim 11, wherein the first wall is configured so that there is insufficient room between the first wall and the second wall to insert a second magnetic read head.

In a still yet further embodiment, the width of the first wall is less than twice the width of the magnetic read head.

In still yet another embodiment, a magnetic stripe card reader includes a magnetic read head configured to read data from a magnetic stripe card, circuitry configured to receive data from the magnetic read head, and a housing that at least partially contains the magnetic read head and the circuitry and defines a card path, where the housing comprises a card path configured to permit visual inspection of the card path.

In a still further embodiment again, the magnetic read head is configured to encrypt data read from a magnetic stripe card and output encrypted data to the circuitry.

In still another embodiment again, the housing comprises a first wall, a second wall, and a reference edge that define the card path.

In a still further additional. embodiment, the length of the first wall is less than the length of the second wall.

In still another additional. embodiment, the length of the first wall is less than half the length of the second wall.

In a yet further embodiment again, the length of the first wall is less than a quarter the length of the second wall.

In yet another embodiment again, the magnetic read head extends out of the second wall and the first wall covers the magnetic read head.

In a yet further additional. embodiment, the first wall is configured so that there is insufficient room between the first wall and the second wall to insert a second magnetic read head.

In yet another additional embodiment, the width of the first wall is less than twice the width of the magnetic read head.

In a further additional embodiment again, at least a portion of the housing is translucent and the translucent portion of the housing is configured to permit visual inspection of the sensor and circuitry.

### BRIEF DESCRIPTION OF THE DRAWINGS

FIG. 1 is a front view of a tamper evident magnetic stripe card reader in accordance with an embodiment of the invention.

FIG. 2 is a side view of a tamper evident magnetic stripe reader in accordance with an embodiment of the invention.

FIG. 3 is a front view of a tamper evident magnetic stripe card reader including a housing having a translucent wall covering a magnetic read head and defining a card path in accordance with an embodiment of the invention.

FIG. 4 is a side view of a tamper evident magnetic stripe card reader including a housing having a translucent wall covering a magnetic read head and defining a card path in accordance with an embodiment of the invention.

FIG. 5 is a front view of a tamper evident magnetic stripe card reader including a status indicator in accordance with an embodiment of the invention.

FIG. 6 is a front view of a tamper evident magnetic stripe card reader including a translucent wall covering a magnetic read head and defining a card path and a status indicator in accordance with an embodiment of the invention.

FIG. 7 is a front view of a tamper evident magnetic stripe card reader including a translucent housing and read head cover in accordance with an embodiment of the invention.

FIG. 8 is a front view of a tamper evident magnetic stripe card reader including translucent housing and read head cover, with a magnetic stripe card partially inserted, in accordance with an embodiment of the invention.

FIG. 9 is a front view of a tamper evident magnetic stripe card reader including translucent housing and read head cover, with a magnetic stripe card fully inserted, in accordance with an embodiment of the invention.

FIG. 10 is a cross-sectional. view of a tamper evident magnetic stripe card reader including translucent housing and read head cover, with a magnetic stripe card inserted, in accordance with an embodiment of the invention.

FIG. 11 is a front view of a near field reader in accordance with an embodiment of the invention.

### DETAILED DISCLOSURE OF THE INVENTION

Turning now to the drawings, tamper evident card readers in accordance with embodiments of the invention are illustrated. In many embodiments, the tamper evident card readers provide users with the ability to visually inspect the card path and the electronics of the card reader. In this way, the user has the ability to identify tampering with the reader and/or the presence of electronics that has been inserted into the card path and/or the reader in an attempt to intercept user data contained on a data bearing instrument including (but not limited to) a magnetic stripe card, radio frequency identification (RFID) tag, or a device configured to communicate via near field communication (NFC) such as an appropriately configured cell phone. In a number of embodiments, the tamper evident card readers include card paths for magnetic stripe cards in which a user can readily visually inspect the entire card path. In several embodiments, the walls of the reader are minimized so that the majority of the card path is bounded by a single wall. In many embodiments, the tamper evident card readers include a transparent housing through which a user can readily observe the internal mechanisms and electronics of the card reader. In a number of embodiments, tamper evident readers in accordance with embodiments of the invention include magnetic read heads that encrypt the data captured by the read head prior to passing the captured data to a microprocessor or other electronics within the reader device. Tamper evident card readers in accordance with embodiments of the invention are discussed further below.

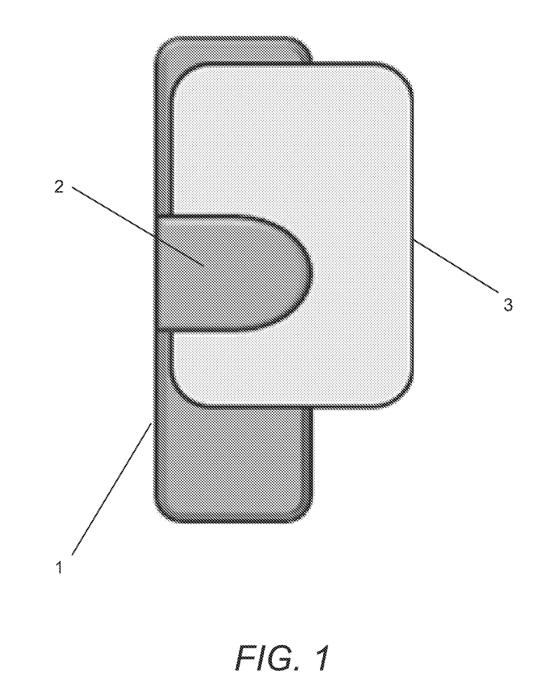

A tamper evident magnetic stripe card reader in accordance with an embodiment of the invention is shown in FIG. 1. The card reader housing (1) is roughly rectangular in shape, although it can be appreciated that the housing may be of any shape that can contain the reader components inside. The read head cover (2) is positioned over the face of the card reader housing (1) on which the magnetic read head, inside the housing, is exposed. The read head cover (2) also forms a channel or slot, bounded by the cover (2) and by the face of the housing (1), to act as a guide when a magnetic stripe card (3) is “swiped” or slid through the channel.

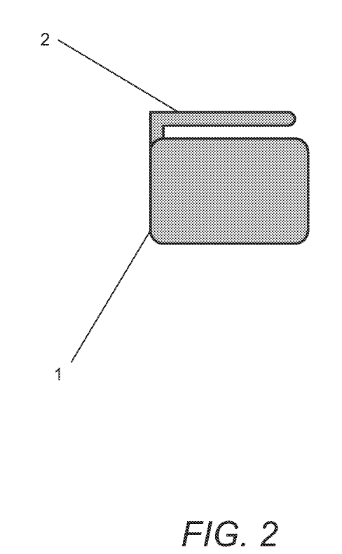

Read head covers on prior art card readers typically extend to at least the length of a standard sized magnetic stripe card to provide a longer channel for “swiping.” With a longer channel, it can be easier or faster for a user to insert a card into the channel and slide the card along the channel. The embodiment of the present invention has a read head cover (2) which is reduced in size. The surface area is minimized to be adequate to cover the magnetic read head and provide a channel for swiping a magnetic stripe card (3), but does not cover sufficient area for a second unauthorized magnetic read head to be hidden behind the read head cover (2). A side view of the card reader shown in FIG. 1 is illustrated in FIG. 2.

Although the card path in the reader housing (1) shown in FIG. 1 is formed by a read head cover (2), the card path can be formed by any two walls. In several embodiments, the walls of the card path are minimized so that the majority of the card path is bounded by a single wall. In addition, the magnetic read head need not be positioned so that an opposite wall protects it. Furthermore, the magnetic read head can be located on either wall of the card path. The width of each wall can be defined as being the dimension parallel to the direction of motion of a magnetic stripe card being swiped past the magnetic read head. In many embodiments, one of the walls defining the card path is hall the width of the other wall. In several embodiments, one of the walls defining the card path is a quarter the width of the card path. In a number of embodiments, the width of one of the walls defining the card path is less than twice the width of the magnetic read head. As is discussed further below, readers for certain types of data bearing documents and/or devices that can perform contactless reading do not include card paths. A variety of techniques in accordance with embodiments of the invention can also be utilized in readers that do not include a card path to provide a user with the opportunity to visually inspect the reader to detect the presence of tampering.

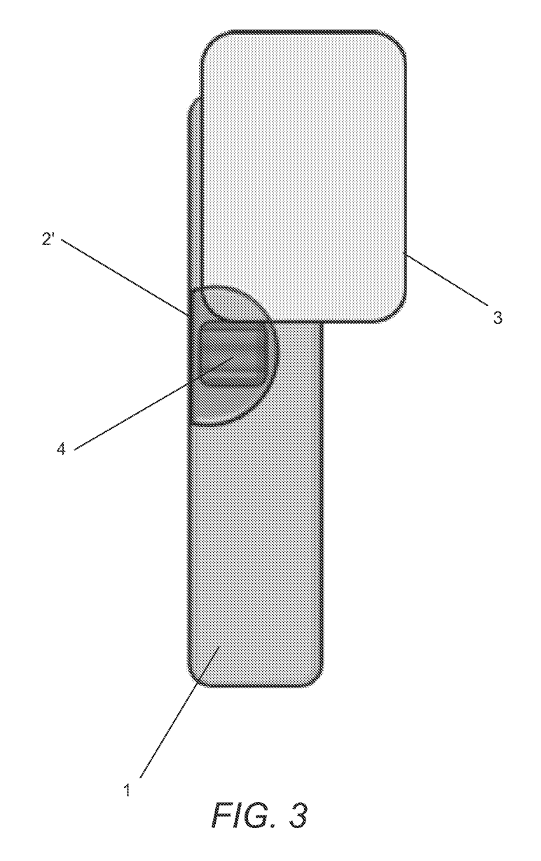

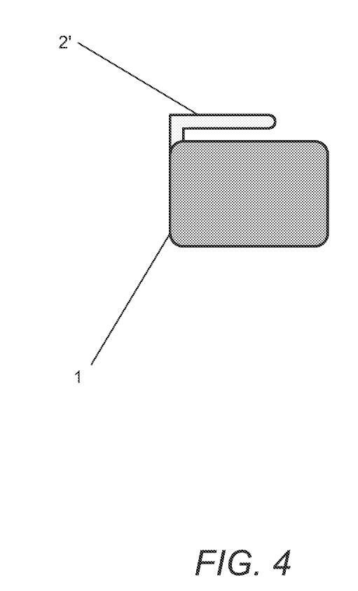

A tamper evident card reader in accordance with another embodiment of the invention is illustrated in FIG. 3. The read head cover (2′) is made of a translucent material such that the magnetic read head (4) can be visually inspected by a customer or user of the device. Although the embodiment shows a card reader with a clear read head cover, any part of the housing or even the entire housing may be made of a transparent material allowing components such as the magnetic read head inside the card reader to be visually inspected. In this way, a user presenting a data bearing document and/or device to such a reader can visually inspect the interior electronics of the reader to detect tampering prior to presenting the document and/or device for reading. A side view of the card reader shown in FIG. 3 is illustrated in FIG. 4.

Although the material utilized in at least the read head cover of the tamper evident reader discussed above with respect to FIGS. 3 and 4 is described as transparent, the materials may be translucent or more opaque, so long as the area behind the material is visible enough that objects can be identified. For the purposes of describing embodiments of the present invention, the term translucent includes any material through which visual inspection can be performed and encompasses at least the entire range of visibility from partial visibility (i.e., viewer can just barely distinguish what the object is) to completely translucent (i.e., no visual obstruction at all). Materials allowing partial visibility can include tinted or colored material. In several embodiments, materials used in the read head cover, housing, and/or other parts of the tamper evident reader are made of a glass, mica, or translucent polycarbonate or ABS plastic material. However, any completely or partially translucent or clear material can be used. In many embodiments, different parts of the tamper evident reader are made of different materials. Furthermore, any adhesive or bonding materials joining parts of the tamper evident reader may be clear or partially clear.

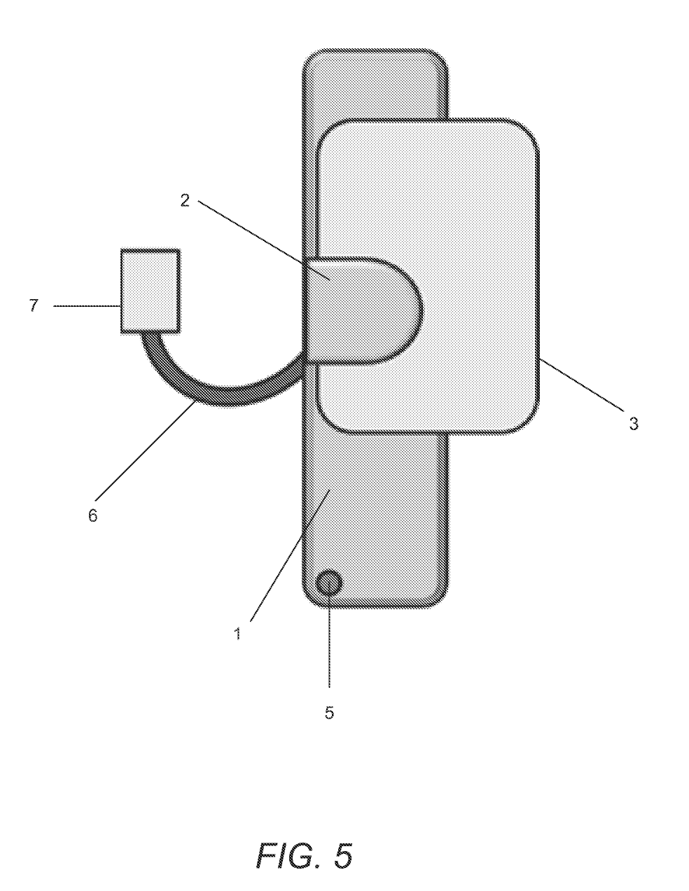

A tamper evident card reader including a status indicator in accordance with yet another embodiment of the invention is shown in FIG. 5. The card reader has a data cable (6) and data connector (7) configured to interface with a computing device or other device. Card information acquired by the card reader from the magnetic stripe card (3) may be sent over the data cable (6) to a computing device attached to the data connector (7). Data connector (7) can be a USB, SCSI, audio plug, or other proprietary connector. An indicator LED (5) lights when the card reader is powered on and operating, when the read head is active and reading information from a magnetic stripe card, and/or to show other status of the card reader.

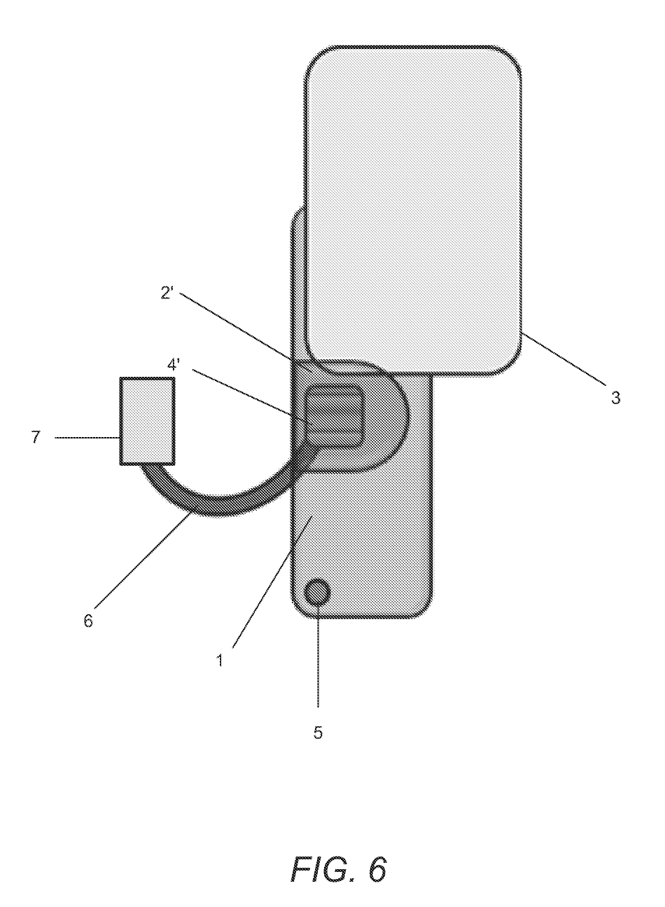

A similar tamper evident card reader in accordance with an embodiment of the invention is shown in FIG. 6. The read head cover (2′) is made of a clear material such that the encrypting magnetic read head (4′) is viewable by a customer or user of the device. The encrypting read head (4′) encrypts the data captured from a magnetic stripe before passing it on to other electronics. Magnetic read heads configured to encrypt data read from a magnetic stripe card are disclosed in U.S. patent application Ser. No. 7,757,953 entitled “Secure Magnetic Stripe Reader” to Hart et al., the disclosure of which is incorporated herein by reference in its entirety.

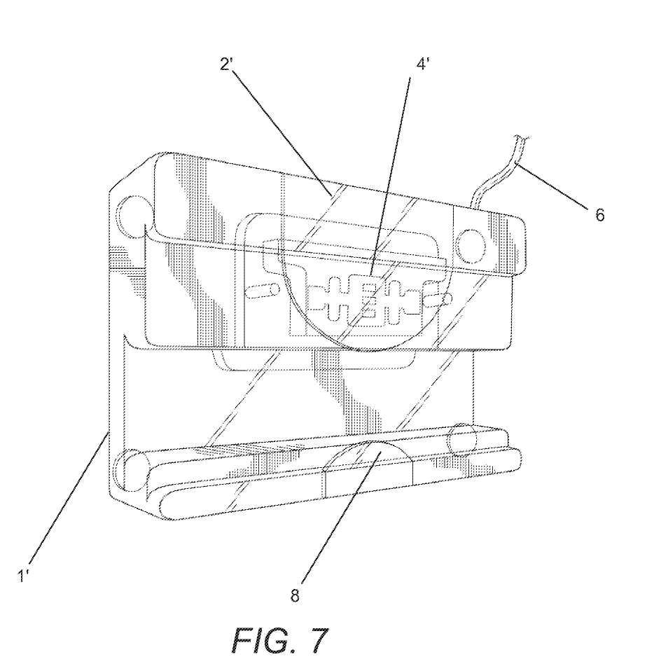

In many embodiments of the invention, most or all of the entire tamper evident card reader housing is made of a translucent material to allow a customer or user of the device to visually the magnetic read head and/or other internal components. A tamper evident card reader, whose housing is entirely translucent, in accordance with an embodiment of the invention is shown in FIG. 7. The card reader housing (1′) and read head cover (2′) are made of a translucent material such that the encrypting magnetic read head (4′) is viewable by a customer or user of the device. The card reader also includes a card retention tab (8) on the opposing side of the card path from the read head cover. The card retention tab can act as an additional wall or guide for the card path. The housing, read head cover, and card retention tab may be made of the same translucent material or different translucent materials.

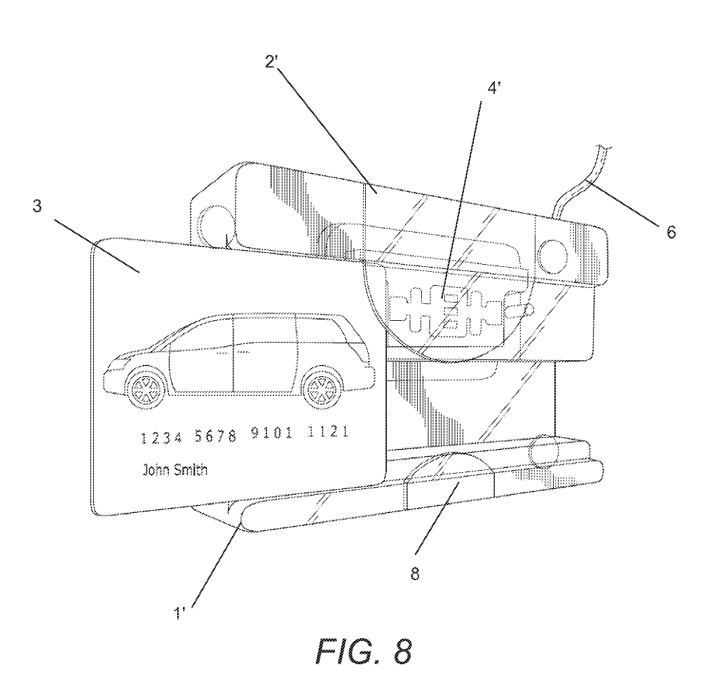

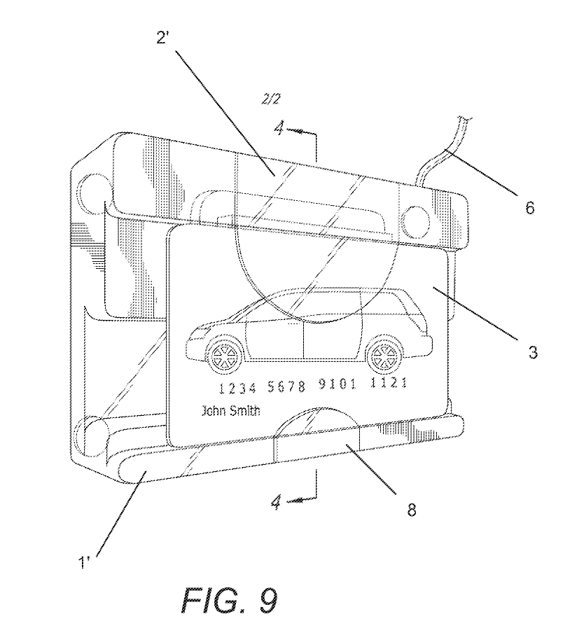

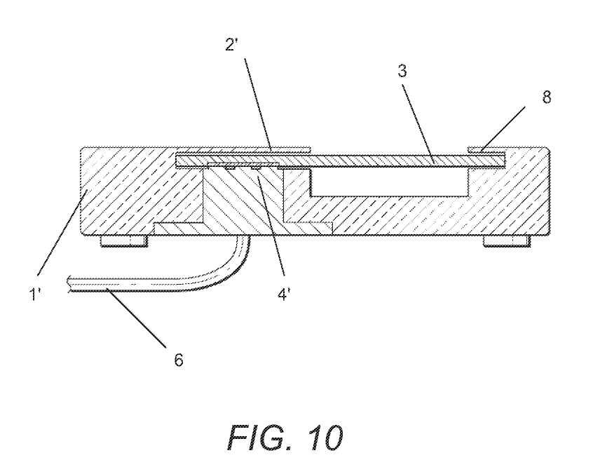

The tamper evident card reader of FIG. 7 is shown with a card (3) partially inserted in FIG. 8 and fully inserted, covering the magnetic read head, in FIG. 9. A cutaway cross-sectional. view of the card reader in FIG. 9 along plane 4 is shown in FIG. 10.

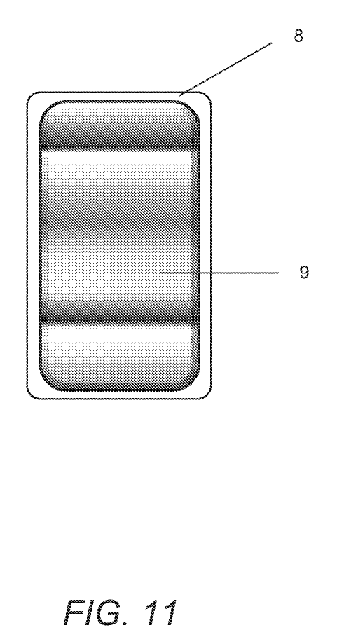

A near-field data reader in accordance with an embodiment of the invention is shown in FIG. 11. The reader is a near-field communications (NFC) device configured to communicate wirelessly and receive payment transaction information from other NFC devices. A portion (9) of the housing (8) is transparent so that components of the device contained within the housing are viewable.

Although the description above contains many specificities, these should not be construed as limiting the scope of the invention but as merely providing illustrations of some of the presently preferred embodiments of the invention. Various other embodiments are possible within its scope. For example, it may be desirable to demonstrate that readers for other types of data-bearing documents such as RFID tags or security cards are resistant to tampering. Such readers may incorporate features of the invention such as minimized read head covers and transparent portions of the housing.

What is claimed is:

1. A data-bearing instrument reader, comprising:
a sensor configured to read data from a data bearing instrument;
circuitry configured to receive data from the sensor; and
a housing that at least partially contains the sensor and the circuitry,
wherein at least a portion of the housing is translucent and the translucent portion of the housing is configured to permit visual inspection of the portions of the sensor and circuitry contained within the housing.

2. The data-bearing instrument reader of claim 1, wherein the sensor is a magnetic read head.

3. The data-bearing instrument reader of claim 2, wherein the magnetic read head is configured to encrypt data read from a data bearing instrument and output encrypted data to the circuitry.

4. The data-bearing instrument reader of claim 2, wherein the housing comprises a card path.

5. The data-bearing instrument of claim 4, wherein the housing is configured to permit visual inspection of the card path.

6. The data-bearing instrument of claim 5, wherein at least a portion of the housing that forms the card path is translucent and permits visual inspection of the card path.

7. The data-bearing instrument of claim 5, wherein the housing comprises a first wall, a second wall, and a reference edge that define the card path.

8. The data-bearing instrument of claim 7, wherein the length of the first wall is less than the length of the second wall.

9. The data-bearing instrument of claim 8, wherein the length of the first wall is less than half the length of the second wall.

10. The data-bearing instrument of claim 8, wherein the length of the first wall is less than a quarter of the length of the second wall.

11. The data-bearing instrument of claim 8, wherein the magnetic read head extends out of the second wall and the first wall covers the magnetic read head.

12. The data-bearing instrument of claim 11, wherein the first wall is configured so that there is insufficient room between the first wall and the second wall to insert a second magnetic read head.

13. The data-bearing instrument of claim 11, wherein the width of the first wall is less than twice the width of the magnetic read head.

14. A magnetic stripe card reader, comprising:
a magnetic read head configured to read data from a magnetic stripe card;
circuitry configured to receive data from the magnetic read head;
a housing that at least partially contains the magnetic read head and the circuitry and defines a card path; and
wherein the housing comprises a card path configured to permit visual. inspection of the card path.

15. The magnetic stripe card reader of claim 14, wherein the magnetic read head is configured to encrypt data read from a magnetic stripe card and output encrypted data to the circuitry.

16. The magnetic stripe card reader of claim 14, wherein the housing comprises a first wall, a second wall, and a reference edge that define the card path.

17. The magnetic stripe card reader of claim 16, wherein the length of the first wall is less than the length of the second wall.

18. The magnetic stripe card reader of claim 17, wherein the length of the first wall is less than half the length of the second wall.

19. The magnetic stripe card reader of claim 18, wherein the length of the first wall is less than a quarter the length of the second wall.

20. The magnetic stripe card reader of claim 17, wherein the magnetic read head extends out of the second wall and the first wall covers the magnetic read head.

21. The magnetic stripe card reader of claim 20, wherein the first wall is configured so that there is insufficient room between the first wall and the second wall to insert a second magnetic read head.

22. The magnetic stripe card reader of claim 20, wherein the width of the first wall is less than twice the width of the magnetic read head.

23. The magnetic stripe card reader of claim 14, wherein at least a portion of the housing is translucent and the translucent portion of the housing is configured to permit visual inspection of the sensor and circuitry.
